(19) United States
(12) Patent Application Publication
(10) Pub. No.: US 2008/0199256 A1
(43) Pub. Date: Aug. 21, 2008

(54) COMPOSITIONS, DEVICES, AND METHODS FOR USE IN ENVIRONMENTAL REMEDIATION

(75) Inventor: Kevin McPhillips, Arbuckle, CA (US)

Correspondence Address: FLIESLER MEYER LLP, 650 CALIFORNIA STREET, 14TH FLOOR, SAN FRANCISCO, CA, 94108, US

(73) Assignee: R.H. Dyck, Inc., Yolo, CA (US)

(21) Appl. No.: 11/873,364

(22) Filed: Oct. 16, 2007

Related U.S. Application Data
(60) Provisional application No. 60/862,181, filed on Oct. 19, 2006.

(51) Int. Cl. B65D 90/24; B09C 1/00; B09B 1/00

(52) U.S. Cl. 405/129.57; 405/129.85

(57) ABSTRACT

What is disclosed are compositions, devices, and methods for use in environmental remediation. The compositions are for use in a variety of environmental remediation barriers including fiber rolls, mats or blankets, and berms. Applications for the use of the compositions, devices, and methods include remediation of aqueous run-off material from contaminated soil, landfill remediation, eutrification of waterways, and revetment of banks.

### CLAIM TO PRIORITY

The present application claims the benefit of priority under 35 U.S.C. § 119(e) to U.S. Provisional Patent Application No. 60/862,181, entitled “COMPOSITIONS, DEVICES, AND METHODS FOR USE IN ENVIRONMENTAL REMEDIATION”, by Kevin McPhillips, filed Oct. 19, 2006, which application is incorporated herein by reference.

### FIELD OF THE ART

The field of art disclosed herein pertains to compositions, devices, and methods suited for a variety of applications in environmental remediation.

### BACKGROUND

The uses of structural barriers for a variety of applications in environmental remediation are generally well described. Several types of environmental remediation barriers (ERBs) are used in earth and hydraulic engineering, such exemplary structures including fiber rolls, mats, blankets, and berms. Originally, major applications of ERBs included erosion and sedimentation control, re-vegetation, and revetment. More recently, the potential for such structures to serve additionally in the capacity of removal of natural and manmade pollutants from residential, industrial, and agricultural sources, and remediation of eutrification has been described.

As the name of one type of ERB, fiber roll, suggests, ERBs packed into a covering, such as a netted material, may be filled with fibers; typically a single natural fiber such as abaca, hemp, jute, flax, sisal, coir, or straw materials. For a major application of fiber-filled ERBs in erosion and sediment control, the purpose of the fiber filling is primarily structural. In that regard, though the natural fibers described are capable of absorbing water, one necessary attribute of the fiber filler has been to provide an effective porosity once packed that allows for the ready passage of water, while promoting the retention of mud, sediment, gravel, and the like. Other desirable attributes of natural fibers used in ERBs include ready availability in high volume and low cost, requirement to be germ, insect and weed free, free of chemical pollutants, ability to degrade after use; thereby obviating creation of harmful waste, and ease of processing into targeted devices.

Materials in addition to natural fibers have been suggested as supplemental constituents in ERBs. Particularly, vegetative matter, as well as nutrients and fertilizers for re-vegetation and revetment have been described. Materials that have been suggested include saw dust, wood chips, bark, compost, flocculants, water absorbents, and pesticides. A major objective in the field has been to establish environmental remediation practices that are consistent with good practices for environmental protection in general. In that regard, the reuse of natural materials, such as saw dust, wood chips, bark, and compost that would otherwise go to waste has been a motive for creating fillings for ERBs.

Especially in consideration of the use of ERBs in functions where the filling has a requirement that is more than structural; moreover where the filling must perform additional multiple functions, such as clarification of runoff water and removal of pollutants, the targeted and judicious selection of materials tailored for such multifunctional use throughout the lifetime of the ERBs still remains a challenge. Accordingly, a need exists for more effective compositions of materials that are multifunctional for a variety of environmental remediation needs, and for a range of ERBs utilizing such compositions and their use.

### BRIEF DESCRIPTION OF DRAWINGS

This invention is described with respect to specific embodiments thereof. Additional aspects can be appreciated from the Figures in which:

FIG. 1; is a side view of a fiber roll.

FIG. 2; is a top view of a blanket.

FIG. 3a; is a front view of a bag berm.

FIG. 3b; is a depiction of the pneumatic application of a composition to create a berm.

FIG. 4a; is a side view of the use of environmental remediation barriers for remediation of livestock waste.

FIG. 4b; is a cross section through a manure pile depicting the of the use of fiber rolls, blankets, and berms for remediation of livestock waste

FIG. 5; is a depiction of the use of fiber rolls, blankets, and berms for remediation of storm water runoff.

FIG. 6a; is the depiction of the use of a fiber roll for the revetment and remediation of eutrification of waterways.

FIG. 6b; is the top view of a pond demonstrating the use of a blanket for remediation of eutrification in a pond.

FIG. 7; is the depiction of the home garden use of a fiber roll including erosion control and re-vegetation.

### DETAILED DESCRIPTION

What will be described and disclosed herein in connection with certain embodiments and procedures is not intended to be limited to the embodiments shown, but is to be accorded the widest scope consistent with the principles and features disclosed. Thus, the intent is to cover all such alternatives, modifications, and equivalents that fall within the spirit and scope of what is presently disclosed as defined by the appended claims.

In this specification and in the claims that follow, reference will be made to a number of terms that shall be defined to have the following meaning:

### Fiber

The term “fiber” has a number of common meanings which include: (1) course indigestible plant matter, consisting primarily of polysaccharides, such as cellulose; and (2) natural or synthetic filaments, e.g. cotton or nylon, and materials made from such filaments. The use of the term “fiber” herein includes both of these definitions. Materials made from natural fibers include materials that are polysaccharide in nature, e.g. cotton or linen, or polypeptide in nature, e.g. wool or silk. Natural fibers containing significant cellulose content are of particular interest to the subject of what is disclosed herein. The broad class of natural cellulose-containing fiber materials includes such examples as flax, jute, sisal, coir, kenaf, ramie, cotton, bagasse, hemp, rice straw, wheat straw, barley straw, and oat straw. These exemplary natural fibers vary considerably in their cellulose fiber content. For example, cotton is composed of 98% cellulose, while bagasse is composed of 50% cellulose, 25% pentosan and 25% lignin. Cotton is an unusual example of a natural fiber material that is almost completely cellulose, and bagasse is more typical. In order to make materials that have higher cellulose fiber content, significant processing is generally required. Cotton, linen, paper, cardboard, and paperboard are examples of materials that are manufactured from processed cellulose. Finally, there are several large classes of synthetic fibers, containing a plurality of members having homologous basic structures that are varied to give different properties. Some examples of classes of synthetic fiber materials include polyamides, polyacrylates, polyesters, and polyacrylamides. Such synthetic fiber materials are made from starting materials that are also synthetic. An interesting type of synthetic fiber includes natural fibers used as starting materials that are chemically modified into manmade fibers. One relevant example of such a class is cellulosics, of which rayon, and cellulose acetate are exemplary.

### Environmental Remediation Barrier

The term “environmental remediation barrier” is used herein to refer to fiber rolls, mats and blankets, and berms. Fiber rolls, also referred to as wattles or fiber logs, are elongate rolls of a natural fiber material contained in a covering, having diameters of about 6-24 inches and 4-25 feet in length. When they are used in the capacity of erosion control, they are typically used along the top, face, and grade breaks of exposed and erodible slopes. Blankets and mats, more commonly known as rolled erosion control products, are commonly used for the short term stabilization of disturbed soil areas such as steep slopes, slopes where erosion hazard is high, slopes where mulch must be anchored, disturbed areas where plants are slow to develop, channels where flow velocities exceed 1.0 m/s, and in channels to be vegetated. As the name suggests, the basic structure of blankets and mats is sheet. Sizes and dimensions of mats and blankets vary tremendously, depending on the application. Some typical dimensions are lengths of about 67 feet to 112 feet, widths of about 4 to 16 feet and thickness of about 0.35 to 0.90 inches. Mats and blankets can be rolled and bundled to produce structures similar in shape to fiber rolls, and used in a similar capacity. Berms may be either of the bag-type, or created on-site, typically by pneumatic application, and are used in the same way that fiber rolls are used. Standard dimensions of bag berms are 1.5 feet long, 1 foot wide, and 3 inches thick, and for use in erosion control are typically filled with gravel, and the like. While those of ordinary skill in the art recognize the use of these structures in earth and hydraulic engineering applications, it is to be understood that the disclosed compositions are useful beyond the above described ERBs.

### Aqueous Run-Off Material

The term “aqueous run-off material” is used to describe the particles that are to be removed from the water during the remediation process. The run-off material may be dissolved, colloidally suspended, non-colloidally suspended or otherwise dispersed or entrapped in the water. Aqueous run-off material includes by definition solutions which contain non aqueous components. Aqueous run-off material includes solutions in which the water composition ranges from approximately 10% to 100%.

### Covering

The term covering is used for any container used to hold the compositions of the ERB. In an embodiment of the present invention, mesh is an outer container which can hold the fiber of the ERB. In an embodiment of the invention Suitable coverings for an ERB include loosely woven fabric or netted materials made from biodegradable or photodegradable materials, or mixtures thereof that enable fluid passage as required for the particular composition and intended environmental application. Suitable biodegradable covering materials include jute, sisal, coir, suitable bast (i.e., flax) material, or combinations thereof. Suitable photodegradable covering materials include polyethylenes, polypropylenes, and polyacetates, or combinations thereof. As will be appreciated by those skilled in the art, suitable covering material will depend upon the environmental application of the compositions, and the ERB.

The covering can be made of one or more fibers selected from the group consisting of natural, synthetic and processed fiber. The covering can include a coating applied to the fiber. The covering can include or be made of an adsorbent, an absorbent or an aggregating agent.

### Container

In an embodiment of the present invention, the aggregating agent, retention agent and/or the reactive agent can be contained within one or more containers held within the ERB. The one or more containers can be located in the center of the ERB with the fiber material packed around the container in order to hold it in the center. In various embodiments of the present invention, the container can be made of similar material to the covering. In alternative embodiments of the invention, the container can have much smaller diameter pores than those of woven materials. The container can have an appropriate mesh or membrane in order to retain the retention agent and/or reactive agent within the container but allow the aqueous run-off material to permeate and or pass through the container. After coming in contact with the agent held in the container, the treated run-off material would exit the container with the material bound to the agent retained in the container. The container can be a material either woven or non woven, a mesh, a membrane or a combination thereof. For example, in the case of retaining aquatic shells or the exoskeleton of anthropods or 10 mm silica spherical beads, mesh with approximately 1 millimeter pores can be used to allow aqueous run-off material to penetrate the mesh but retaining the shells or the exoskeletons. In the case of retaining inorganic salts which are water soluble (e.g., sodium sulfate) a membrane with approximately 1 micron diameter pores can be used to allow aqueous run-off material to penetrate the mesh but retaining the sodium sulfate and bound volatile organic molecules. In contrast, in the case of bacteria, nano-membranes can be used with approximately 1 nanometer pores as the container (or incorporated into the container to define such pores) to retain the bacteria within the ERB. In an embodiment of the present invention, the container can be a membrane bioreactor within which a reactive agent can be held. The container being held inside the ERB. In various embodiments of the invention, one or more containers each containing one or more aggregating agent and/or one or more retention agent and/or one or more reactive agent can be contained within an ERB.

The container can be made of one or more fibers selected from the group consisting of natural, synthetic and processed fiber. The container can include a coating applied to the fiber. The container can include or be made of an adsorbent, an absorbent or an aggregating agent.

By placing a compound that represents a health hazard in a container in the middle of the ERB, once assembled, the hazardous compound can be contained in such a manner that the ERB can be handled without the hazardous compound being handled. By placing a compound that is light sensitive in a container in the middle of the ERB, once assembled, the ERB can be handled in such a manner that the light sensitive compound is not directly irradiated with light.

### Inner Section

In an embodiment of the invention, a wattle ERB can be produced in which the inner area of the wattle is not packed with fiber. In an embodiment of the invention, the wattle can be filled by an auger based machine in which the bore of the auger is increased to leave a dead volume in the center of the wattle. In an alternative embodiment of the invention, the wattle can be filled by a plunger based machine in which the plunger slides along a central beam in the middle of the wattle and thereby does not fill the center of the wattle. A wattle with a dead volume in the center allows material to be inserted into the dead volume. The material that is placed at either end of the dead volume (i.e., before and after the dead volume has been filled) together with the fiber placed in the wattle can all serve to keep the material in place.

Some chemical compounds can be used to treat run-off water thereby removing bacteria and other health hazards and yet the compound itself in a concentrated form represents a health hazard when handled without protective gloves. By placing a compound that represents such a health hazard in the middle of the ERB, once assembled, the risk of the hazardous compound adversely affecting a handler can be minimized. In this manner the ERB can be handled by a person taking other required precautions, without a significant risk of being in direct contact with the hazardous compound. In an embodiment of the invention, by placing a compound that is light sensitive in the middle of the ERB, once assembled, the ERB can be handled in such a manner that the light sensitive compound is not directly irradiated with light. In an embodiment where the ERB is a wattle, the fiber surrounding the inner dead volume of the wattle containing the compound or the fiber surrounding the container containing the compound can protect a wattle handler from contact with a hazardous compound or direct light irradiation of a light sensitive compound.

### Impervious Blanket

The term “impervious blanket” refers to a plastic layer, film or material which is impervious to aqueous run-off material. A horizontal impervious blanket can be provided to direct the path of seepage of aqueous run-off material. The impervious blanket can be connected to a filter to treat the aqueous run-off material. Suitable materials for an impervious blanket include polyethylenes, polypropylenes, and polyacetates, or combinations thereof. To avoid long term cracking of the impervious blanket, the material should not be solely plastic. An approximately 0.3 meter thick layer of random material can be spread over the blanket to prevent cracking due to exposure to atmosphere. In an embodiment of the present invention, an impervious blanket can be used to line a landfill prior to storing contaminated land fill material. An impervious blanket can also be used to cover a land fill site to restrict the amount of aqueous run-off material that enters a contaminated land fill site. By restricting the amount of rain water that enters a land fill site, the treatment of aqueous run-off material exiting the land fill site can be reduced and thereby the treatment can be more efficiently managed. Reference may be made to IS: 1498-1970 for suitability of blankets for soils. The impervious blanket may be designed in accordance with IS: 8414-1977. As a general guideline, impervious blanket with a minimum thickness of approximately 0.1 meter and a minimum length of 5 times the maximum water head measured from upstream toe of core can be provided.

The choice of seepage control methods to use in treating contaminated material in land fill sites depends on a number of factors including the nature of the site, the foundations and the abutment. Characterization of the foundation or abutment and identification of potential seepage paths can be important. Before any method of seepage control is implemented, the area must be thoroughly explored and tested to assure that the method chosen will apply to the general conditions as well as the conditions locally encountered and will serve the intended purpose. In many cases, a combination of methods can be used to the best advantage for rock foundations or abutments. The use of different control methods becomes particularly important when there is a change in the character of the foundation from one location to another, or a change in seepage characteristics between the foundation and the abutment. Seepage can be controlled by utilizing an impervious layer together with drainage through appropriate ERBs to treat the aqueous run-off material from the site. It should be noted that the possibility exists for unmitigated rain fall to cause substantial increases in seepage. Such increases are normally accompanied by reductions in uplift pressures and are therefore desirable if the increased seepage produces no detrimental side effects. Alternatively, the rainfall can be directed away from the site. The impervious layer, can be sandwiched between an upper and a lower pervious layer, with seepage through the ERBs connecting the layers. Where the thicknesses of the impervious and upper pervious are sufficient, the layers may be able to resist the upward seepage pressures existing in the lower pervious layer and thus remain stable. Selection of seepage through the ERBs is normally obtained by extending the impervious layer within the abutment.

### Remediation Process

The term “remediation process” refers to the treatment of aqueous run-off material such that the run-off material is isolated or separated from the water. In addition, the remediation process refers to the retention of the isolated or separated species and the sediment. Cations and anions are positively and negatively charges species which exist in solution and are formed by the dissociation of salts of organic and inorganic compounds. For example, common salt (NaCl) when dissolved in water dissociates into the cation Na⁺ and the anion Cl⁻. Similarly, other organic and inorganic compounds can be either trapped or dissolved in solution and contained in aqueous run-off material. The trapped or dissolved molecules may or may not form ions in solution depending on their structure, net charge and the pH of the water. The remediation process refers to the retention of these molecules and ions isolated from aqueous run-off material.

### Aggregation Agent

The term “aggregation agent” refers to a molecule which stimulates the process in which material colloidally suspended becomes destabilized, thereby forming larger associations of particles. These larger associations of particles are referred to as aggregates. The terms “coagulation” and “flocculation” are frequently used interchangeably to describe the process of formation of aggregates. The terms “coagulant” and “flocculent” are used to describe agents promoting aggregation in solution, and have been used notably in the discussion of treatment of water and wastewater. Here, the term “aggregation” is used to avoid confusion over the mixed use of the terminology surrounding “coagulation” and “flocculation”, since “aggregation” unambiguously refers to the process of forming aggregates. The term “aggregating agent” refers to a wide range of constituents that act to promote aggregation, and occur in a wide variety of classes of materials including, polymers, minerals, clays, and inorganics. Examples of aggregating agents meeting the attributes required for use in the disclosed compositions include: (1) polymers; exemplary polymers are taken from the groups of polyacrylamides, polyamines, polydadmacs, chitosans; (2) minerals such as gypsum and calcite; (3) clays such as bentonite and talc; and (4) inorganics such as polyaluminum and polyferric salts.

One aspect of a coagulation and/or flocculation agent is its capacity to coagulate and/or flocculate agents in water. In order to increase the surface area of coagulation and/or flocculation agents, these agents are preferably made up of particles of less than 10 mm in diameter. Coagulation and/or flocculation agents include for example, aquatic shells and the exoskeleton of anthropods. The coagulation and flocculation agents can function as highly absorptive or adsorptive material. The coagulation and flocculation agents can interact with material in the water either via formation of chemical and/or physical bonds. The action of an aggregating agent and the fiber material can be improved through the use of a binding agent.

### Polymer

The term “polymer” refers to both natural polymer materials including chitin, chitosan, conchiolin and synthetic polymers such as polyacrylamide, polyamine and polydadmac. Synthetic polymers include organic polymers, inorganic polymers and mixtures thereof including inorganic fillers of organic polymers and organic fillers of inorganic polymers.

### Crystalline Polymer

The term “crystalline polymer” refers to any polymer in which more than approximately 60% by weight of the polymer molecules are arranged in a regular order and pattern, e.g., polypropylene, syndiotactic polystyrene, nylon, kelvar, nomex, polyketones and polyarylate liquid crystalline polymer.

### Retention Agent

The term “retention agent” refers to material which can be used to bind molecules present in the aqueous run-off material. Examples of retention agent include: silica, modified silica, mesoporous silica, hydroxy apatite, zirconia, cellulose, agarose, cepharose, polyacrylamide, polyamide, polystyrene, modified polymer and granulated activated carbon. In an embodiment of the invention a silica binding agent can be modified with 3-aminopropyl-triethoxysilane which can then be reacted with 5-formyl-8-hydroxyquinoline to generate a surface with 8-quinolinol groups for binding of cations. Alkanol quaternary ion or other amines can be derivatized or grafted onto polymer beads to produce a modified polymer with anion exchange properties. Examples of polymer beads include polystyrene-divinyl benzene cross polymer porous core beads. The beads can have an approximately 20 micron-approximately 200 micron diameter and a pore size of approximately 0.1 micron-approximately 10 microns. Carbonate, bicarbonate or hydroxide ions can be used as an eluent to release captured polyphosphates, oxyanions, EDTA complexes, metal cyanide complexes, and hydrophobic anions such as iodide, thiosulfate, and thiocyanate. In an embodiment of the invention, aquatic shells and the exoskeleton of anthropods can also be used as a retention agent. The material resulting from adhering a retention agent to a fiber with a binding agent is termed a “modified retention agent”.

In various embodiments of the present invention, silica can be used as the retention agent to extract hexachlorobenze, alpha-HCH, Lindane (gamma-HCH), Heptachlor, Heptachlorepoxid, 2,4-dichlorophenoxyacetic acid (2,4-D), o,p′-Dichloro-Diphenyl-dichloro Ethylene (DDE), p,p′-DDE, Dieldrin, o,p′-Dichloro-Diphenyl-Trichloroethane (DDT), p,p′-DDT, and other organochlorine, organophosphorous, nitrogen containing and carbamate pesticides. In an embodiment of the present invention, polar pesticides can be more efficiently extracted by decreasing the hydrophilicity of the retention agent. In various embodiments of the present invention, the retention agent to extract pesticides is selected from the group consisting of styrene divinylbenzene, acetyl modified styrene divinylbenzene, benzoyl modified styrene divinylbenzene and o-carboxybenzoyl modified styrene divinylbenzene copolymers. In an embodiment of the present invention, 3(trimethoxysilyl)propylamine can be used as the retention agent to extract pesticides. In an embodiment of the present invention, graphitized carbon black can be used as the retention agent to extract pesticides.

In an embodiment of the present invention, silica can be used as a retaining material to extract phosphate anions from aqueous solutions. In an embodiment of the present invention, silica can be used as a retaining material to extract nitrate anions from aqueous run-off material.

In an embodiment of the invention, anhydrous sodium sulfate can be used for the extraction of mono and polycyclic aromatic hydrocarbons, volatile organic compounds and semi-volatile organic compounds from aqueous run-off material. The product resulting from binding a clathrate compound containing anhydrous sodium sulfate to a fiber with a binding agent is termed a modified retention agent.

In an embodiment of the present invention, silica modified with organosulfur as a donor group can be used as the retention agent to extract metal ions. For example, mercaptopropyl modified silica can be used to extract heavy metal ions from aqueous run-off material. In alternative embodiments of the present invention, the retention agent to extract inorganic ions from aqueous run-off material can be phosphotungstic acid modified alumina or ethylenediamine modified silica. These retention agent can be used to extract Pt(II), Pd(II), Rh(II), Ru(II), Ru(III), Ir(II), Ni(II), Cu(II), Cu(III), Fe(II) and Fe(III) ions.

In an embodiment of the invention, one or more retention agents act as chelating agents to extract ions from the run-off material. In an embodiment of the present invention, the retention agent can be modified with a polymer material selected from the group consisting of poly-(N-ethyl-4-vinylpyridinium bromide), poly-(dimethyldiallylammonium chloride), poly-(hexamethylene guanidinium hydrochloride) and 2,5-ionene or combinations thereof to extract metal ions. Alternatively, the retention agent can be modified with poly-(4-vinyl pyridine) to extract Cr(III), Cr(VI) and Pb(II) ions from solution. The retention agent can be modified with histidine to extract Zn(III) and Mn(II) ions from solution. The retention agent can also be modified with 3-(2-aminoethyl)aminopropyl trimethoxysilane to extract Ru(II) or Ru(III) ions from solution. In an embodiment of the present invention, the retention agent can be modified to produce 8-quinolinol groups which can be used to extract Cu(II), Pb(II), Ni(II), Fe(III), Cd(II), Zn(II) and Co(II) ions from solution. In an embodiment of the present invention, the retention agent can be modified with bis(2,4-dimethoxy benzaldehyde) ethylene di-imine to extract Cu(II) and Pb(II) ions from solution. In an embodiment of the present invention, the retention agent can be modified with tris (methoxy)mercaptopropylsilane or 2-Amino-1,3,4-thiadiazole to extract heavy metals such as Hg(II), Cd(II), Pb(II), Cu(II), Zn(II), Co(II), Ni(II) and Mn(II) ions from solution.

In various embodiments of the present invention, different polymeric agents can be used to modify the retention agent resulting in variations in selectivity, stability, rate of sorption and capacity based on the pH of the solution and the ionic strength (the concentration of the cations in solution). In an embodiment of the present invention, the retention agent can be used for the simultaneous binding of weakly and strongly retained anions and heavy metals. In an embodiment of the invention, a modified silica can result in 10 mm spherical beads. In an embodiment of the invention, modified silica can compete and capture metal ions from solutions containing EDTA ions.

### Reactive Agent

The term “reactive agent” refers to any molecule used to chemically, enzymatically or catalytically react species present in aqueous run-off material, wherein a chemical reaction changes the composition of molecules in the run-off material. Reactive agents include bacteria, fungi and micro-organisms that can react with nitrites, nitrates and volatile organic compounds present in the run-off. Biological solids can also be removed from aqueous run-off material using a reactive agent. The action of the reactive agent is important to counter proliferation of filamentous micro-organisms, un-flocculated microbial cells and other colloidal components. The material resulting from adhering a reactive agent to a fiber with a binding agent is termed a “modified reactive agent”.

Reactive agents include chemoautotrophs, which grow by powering CO₂ fixation with the energy released by the oxidation of a variety of redox substrates. Electron donors utilized by these organisms include reduced sulfur (H₂S, S₂O₃⁻², S^{o}, etc.), reduced iron (e.g., Fe⁺², pyrite), reduced nitrogen (NH₃, NO₂⁻) and H₂, while O₂, NO₃⁻, SO₄⁻², and Fe⁺³ can serve as electron acceptors. By coupling the oxidation and reduction of inorganic compounds to the generation of biomass, the activities of these organisms tie the geochemical cycle of their redox substrates to the carbon, nitrogen, and phosphorus cycles thereby producing byproducts which are utilized by a variety of flora.

Reactive agents include bacteria which utilize volatile fatty acids (VFA) as a carbon source for microbial action. The VFA's are generally metabolized by sulfate reducing bacteria (SRB), such as Desulfovibrio desulfuricans, generating H₂S gas as a by-product. However, nitrate in run-off water containing VFA stimulates the growth of denitrifying bacteria (DNB), such as Thiobacillus denitrificans. These DNB are more voracious competitors than the SRB's for the VFA in a given environment. Further, the microbes convert the nitrate into volatile forms of nitrogen, thereby detoxifying the water. The volatile forms of nitrogen are also available for incorporation into plant life forms. By reducing the nitrate levels present in the water, the possibility of nitrate ingestion by humans and conversion into nitrite through the action of bacteria or fungi is minimized. Nitrites are generally much more toxic than nitrates. Nitrites are formed from nitrates during ruminant digestion and may also occur if stored plant materials heat up or are attacked by bacteria or fungi. When high levels of nitrites accumulate in the gastrointestinal tract, they are absorbed into the bloodstream. Nitrite in the bloodstream changes hemoglobin to met-hemoglobin. If enough met-hemoglobin is produced, an animal can suffocate and die. Some animals can tolerate up to 50% conversion of their hemoglobin without ill-effects; however, when more than 80% hemoglobin is converted, death occurs.

In order to treat aqueous run-off material using bacteria, the bacteria, fungi or micro-organisms can be directly immobilized on a fiber. In an embodiment of the present invention, Agar can be used as a binding agent to adhere bacteria, fungi and/or micro-organisms onto fiber. Alternatively, DNB can be inserted or grown in a clathrate compound and the clathrate compound can be held in a container or adhered to the fiber using a binding agent.

Alternatively, the reactive agent may be used to remove bacteria from aqueous run-off material. For example, the reactive agent may be an anti-bacterial agent. One class of antibacterial agent are bacteria oxidizing agents such as chlorine. Chlorine treatment can control a variety of organisms including iron, slime and sulfate-reducing bacteria. Chlorine can also prevent nitrates from being reduced to the nitrite form and remove metals such as iron from water by oxidizing them, in the case of clear soluble iron into the filterable reddish insoluble form. A source of chlorine such as an alkali metal or alkali earth metal salt of hypochlorite, trichloro-S-triazinetrione, sodium dichloro-S-triazinetrione, cyanuric acid can be used as an antibacterial agent. In an alternative embodiment of the invention a source of bromine such as bromo-chloro-5,5 dimethylhydantoin can be used as an antibacterial agent. In embodiments of the invention, the antibacterial agent can be a hazardous compound. In embodiments of the invention, the antibacterial agent can be light sensitive. In various embodiments of the invention, the antibacterial agent can be in a pellet, tablet or stick form, inserted inside the ERB. In an alternative embodiment of the invention, the antibacterial agent can be sprayed onto a fiber. The antibacterial agent can be sprayed together with an inert compound in order to reduce the rate of solubilization of the antibacterial agent.

### Binding Agent

The term “binding agent” refers to any material, which can be used to chemically or physically bind one or more of the components to be included in the ERB. For example, a coagulation and/or flocculation agent can be adhered to a fiber with a binding agent. Alternatively, a retention agent can be impregnated on a fiber. Or a silicone rubber elastomer can be used to bind a crystalline polymer to a fiber material. Agar can be used to coat a reactive agent such as specific bacteria onto a fiber. Adhesives and/or welding can also be used as a binding process to adhere nano-tube clathrates to fibers. As described, binding agents can be used to bind polymers to fibers whereby the polymers selectively chelate ions present in the aqueous run-off material and extract those ions from the solution. In an embodiment of the invention, means for holding the one or more retention agents within the outer covering of a remediation barrier do not include a binding agent.

A retention agent can be affixed to the fiber using a variety of methods depending on the method used to make the retention agent. For example, the retention agent can be adhered to a fiber directly after extrusion. Alternative methods for making the retention agent include: lay out, impregnation, molding, infusion, filament winding and pultrusion. All these methods involve impregnating fibers with a polymer resin (e.g., epoxy, polyester). The process can also start with prepregs where the fibers are already impregnated with resin, shaping the parts in various ways and then curing the polymer by heat and pressure. The retention agent can also be adhered to a fiber with a binding agent.

In an alternative embodiment of the invention, the retention agent can be coated on magnetite nano-particles which are then held in-situ by the action of a magnetic material and the magnetic field. The magnetic retention agent can be impregnated or otherwise embedded in a fiber. The retention agent surface can be modified with an amino silane coupling agent, N-[3-(trimethyoxysilyl) propyl]-ethylenediamine, and amine group can be derivatized with an acidic group and more permanently immobilized by cross-linking with gluteraldehye. In such an embodiment, the magnetic retention agent can be retained within the wattle and periodically regenerated by applying an appropriate magnetic field, whereupon the magnetic material can be released from the wattle, extracted from the retention agent, treated or otherwise regenerated and then reinserted into the wattle, whereupon the magnetic field is again used to retain the retention agent. The material resulting from binding a retention agent to a fiber with a magnetic field is termed a modified retention agent. For example, the magnetized nano-particles can be held within a container. The container can be held inside the ERB.

In an embodiment of the present invention, the binding agent can be mixed with a reactive agent to reduce the solubility of the reactive agent. By reducing the solubility of the reactive agent, the location of the reaction inside the ERB can be assured. Thus the binding agent can be any partially insoluble compound which when mixed with a reactive compound results in a suitable rate of solubilization. The binding agent can act as an excipient for delivering the reactive agent. The binding agent can be an inert compound present in aqueous run-off material such as calcium carbonate. The binding agent and the reactive agent can be sprayed onto a fiber or other substrate to be introduced into the ERB in order to insure the desired rate of solubilization of the reactive agent. In various embodiments of the invention, in one or more of the above ways the binding agent can adjust the solubility of the reactive agent.

In an embodiment of the present invention, a clathrate compound can be used to encompass, immobilize or otherwise retain a smaller molecule. In various embodiments of the present invention, the smaller molecule can be a reactive agent or a retention agent. A clathrate is any molecule capable of encompassing and containing another molecule in the gas liquid or solid phase when interacting with run-off materials in the gas liquid or solid phases over a range of temperatures and pressures. In an embodiment of the invention, a clathrate is a chemical substance consisting of a lattice of one type of molecule surrounding or substantially surrounding a second type of molecule. In an embodiment of the invention, a carbon nano-tube is an example of a clathrate compound that can immobilize another molecule. In an alternative embodiment of the invention, a fullerene is an example of a clathrate compound that can immobilize another molecule. A clathrate can encompass a retention agent, such that the retention agent can continue to bind. For example, a retention agent can be trapped within a nano-tube which is then held within a container. The nano-particles can be held in containers using nano-membranes, where the containers are held inside the ERB.

The arc-evaporation method, can be used to produce nano-tubes. The method involves passing a current of about 50 Amps between two graphite electrodes in an atmosphere of helium. A discharge causes graphite to vaporize, some of it condensing on the walls of the reaction vessel and some of it on the cathode. The deposit on the cathode contains the carbon nano-tubes. Single-walled nano-tubes are produced when Co and Ni or some other metal is added to the anode. Growing carbon nano-tubes in alignment on a silicon substrate can produce a thread. Spinning can be used to incorporate the thread into a fiber. Applying a voltage to the thread can be used to “weld” the thread to another material for retention onto the fiber. In an embodiment of the present invention, the clathrate compound can be used to encompass and thereby immobilize polymers that selectively chelate ions in solution and thereby the clathrate can selectively extract ions from aqueous run-off material. The material resulting from binding a clathrate compound containing a binding agent or a retention agent to a fiber with a binding agent is termed a modified retention agent. In an embodiment of the present invention, the clathrate compound can be used to encompass and thereby immobilize modified silica that selectively binds molecules from aqueous run-off material. In an embodiment of the present invention, a clathrate compound can be used to immobilize the flocculation agent used to treat aqueous run-off material.

In an alternative embodiment of the present invention, the aggregating agent, retention agent and/or the reactive agent can be directly bound to the fiber and thereby held within the ERB rather than using a container held within the ERB. In a further embodiment of the invention, the aggregating agent, retention agent and/or the reactive agent can be directly bound to the fiber and held within a container. A container not only can be used to retain aggregating agent, retention agent and/or the reactive agent, which would otherwise not be retained within the outer mesh of the ERB, but also allows the aggregating agent, retention agent and/or the reactive agent to be withdrawn from the ERB for treatment or disposal.

In an embodiment of the present invention, the retention agent and/or the retention agent can be treated to regenerate the binding capacity of the retention agent. In an embodiment of the present invention, the retention agent can be treated to release the captured species thereby regenerating the retention agent. For example, the retention agent can be treated with one or more acid washes to release the captured species. Alternatively, the retention agent can be treated with organic solvents to release the captured species. In another embodiment of the invention, the retention agent can be treated with high salt gradients to release the captured species. In all these embodiments of the invention, the retention agent can be recycled after release of the captured species. In an alternative embodiment of the invention, the captured species can be trapped and collected after release from the retention agent. In this way, the ions can for example form stable salts which can then be used as a source of the ions.

### Adsorption

The term “adsorption” refers to the accumulation of gases, liquids, or solids on the surface of a solid or liquid. In contrast, though in the same context, “absorption” is generally defined as the uniform uptake of gases and liquids throughout a solid material. Both processes are important in the removal of pollutants in the environment, and it is to be recognized that many materials may act in both capacities.

### Adsorbent

The term “adsorbent” is used for materials in the described compositions selected to adsorb pollutants of the targeted applications, though it is understood that such materials may also act to absorb other species.

### Absorbent

The term “absorbent” is used for materials of the described compositions selected to absorb undesirable bulk materials of the targeted applications, though it is understood that such materials may adsorb other species.

Adsorbents meeting the attributes required for use in the described compositions occur in a wide variety of classes of materials including perlites, zeolites, clays, and carbonaceous adsorbents. Given the complexity of these materials, there are many forms and variations of materials in each class. Perlite is a generic term for a natural glass material, characterized by having, good insulating properties, light weight, neutral pH, and good adsorption properties for a wide range of chemical species; most notably organic. Zeolites are naturally occurring minerals classified in the silicate family. They are characterized by the openness of their structure that permits large ions and molecules to diffuse into their structure. Their channel sizes control the size of molecule that can pass through, and so they act as a chemical sieve. They have proven effective in removing numerous alkali, alkali earth, and transition metal ions, as well as ammonia from water. As previously mentioned, clays are naturally occurring complex minerals within the phyllosilicate group. Given their chemical structures, many types of clay are also highly effective adsorbents of a broad range of chemical species. Examples of clays that are excellent adsorbents include vermiculite and organoclay. Carbonaceous adsorbents are a diverse group of adsorbents ranging from activated charcoal, created from natural sources, such as wood, to carbonized adsorbents formed from the pyrolysis of synthetic organic materials.

The term retention agent will also be used to refer to modified zeolites. In an embodiment of the invention, zeolites are modified with long chain alkyl quaternary ammonium ions. In various embodiments of the present invention, modified zeolites showed different selectivity, stability, rate of sorption and capacity based on the surface area of the zeolite, the other physical properties of the zeolite, the external cation exchange capacity, the pH of the solution and the ionic strength.

One aspect of absorbents is their capacity for uptake of a liquid. It is desirable for this application that the adsorbent take up a significant volume of bulk liquid, without significant change in packed volume. Additionally, it is desirable for the adsorbent to be readily disposed of without creating environmental contamination or high cost. Materials meeting the above criteria are frequently material composites with significant portions of natural materials. Absorbents meeting the attributes required for use in the described compositions include peat-based, cotton fiber-based, bagasse-based, and urethane-based absorbents.

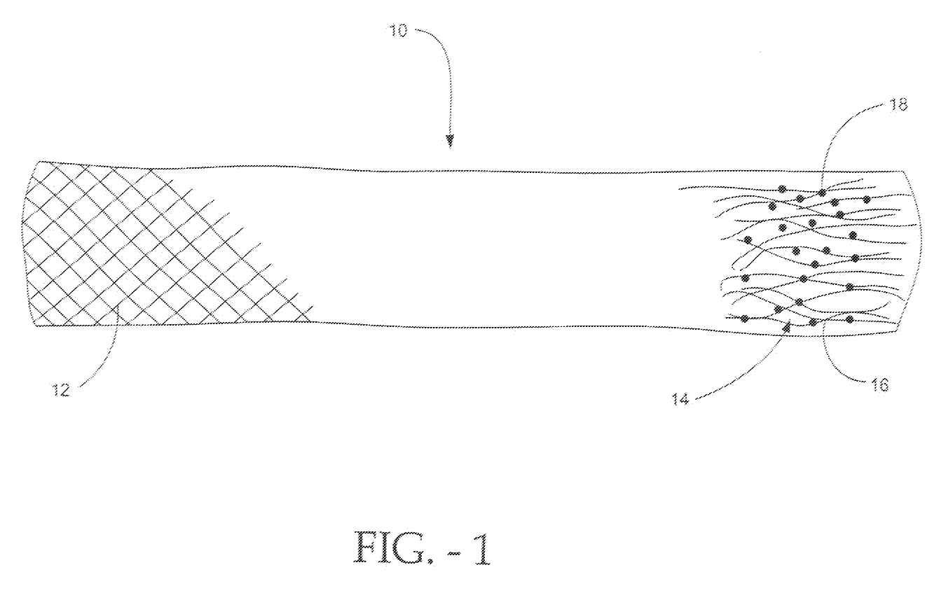

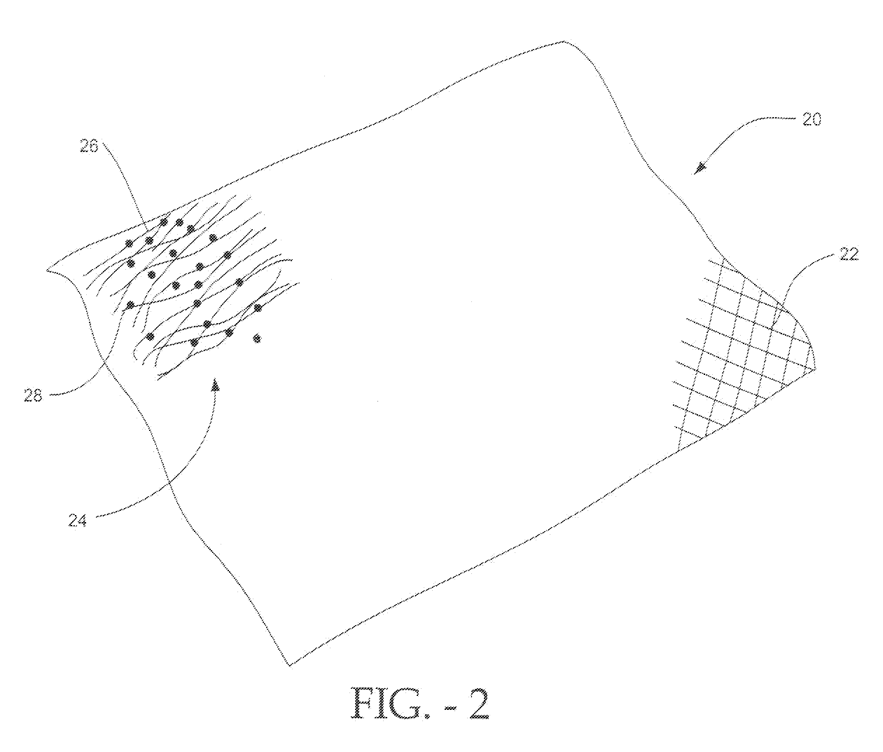

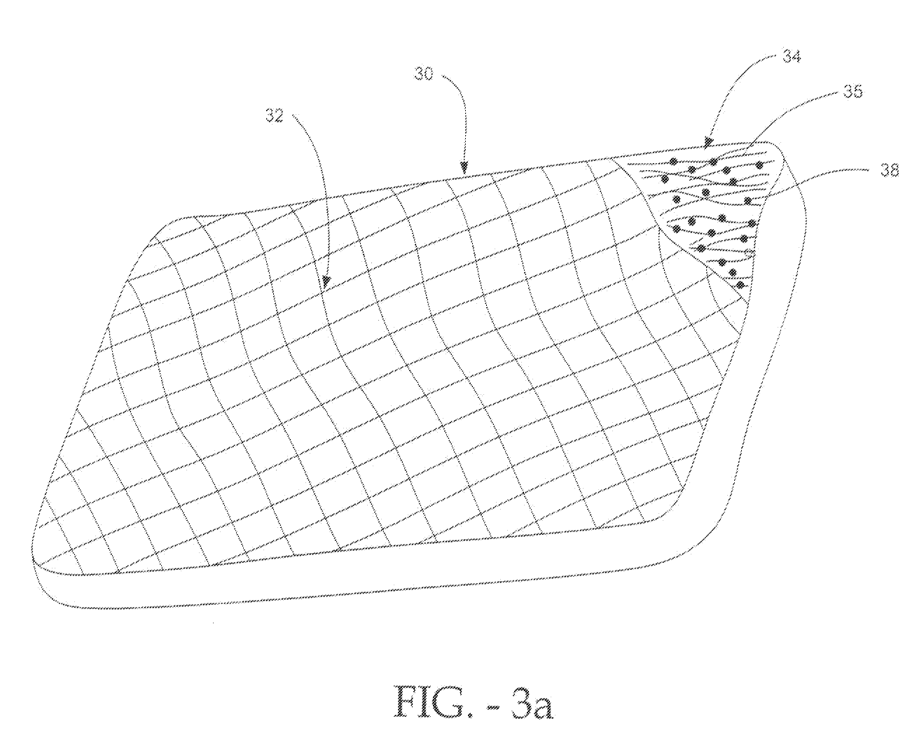

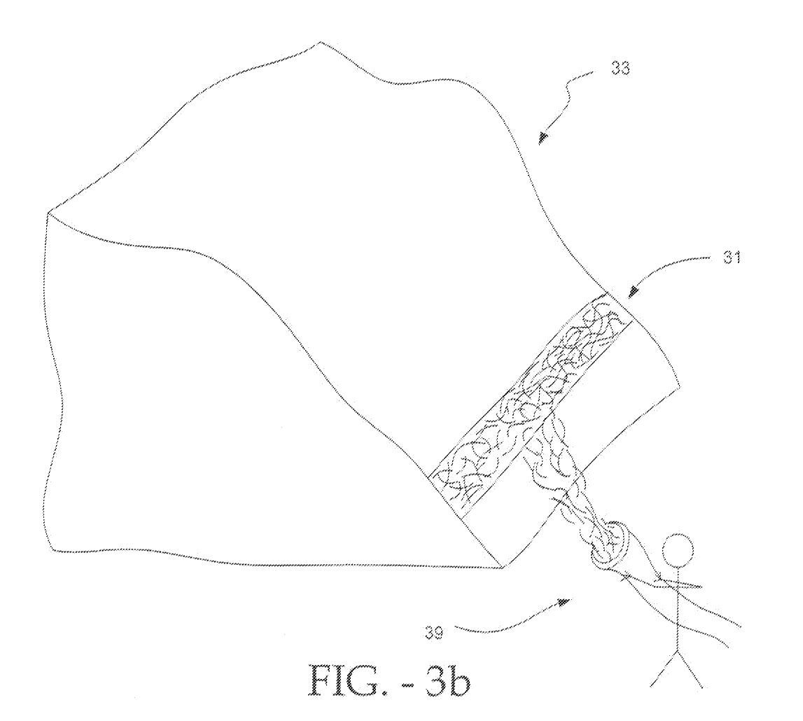

Referring now to FIG. 1-3, exemplary environmental remediation barriers are shown. In FIG. 1 the side view of a fiber roll 10 is illustrated as being uniformly tubular, and therefore of circular cross-section. The fiber roll 10 is composed of netted material 12 surrounding a filling 14. In the filling 14, two forms of constituents of the disclosed composition are illustrated; fiber 16, and particle 18. FIG. 2 shows an ERB in the form of a mat or blanket 20 with netted material 22, a filling 24, illustrating fiber 26 and particle 28 forms of the constituents of the disclosed composition. In FIGS. 3a and 3b, different types of berms are shown. In FIG. 3a, a bag berm 30 is shown, having a covering 32 of a cloth, and a filling 34, illustrating fiber 36 and particle 38 forms of the constituents of the disclosed composition. FIG. 3b illustrates the on-site creation of a berm 31 on hillside 33 through the use pneumatic application of filling 34.

As will be appreciated by those of skill in the art, ERBs contained in coverings, such as fiber roll 10, mat or blanket 20, and bag berm 30 can take on a plurality of shapes and aspect ratios that may be useful for the functions served. For example, the fiber roll 10 can be tubular with an oval, square, rectangular, ovoid or other dimensioned cross-section. Likewise, mats and blankets 20, and bag berms 30 need not be square, and may take on a variety of aspect ratios. Additionally, mats and blankets may be further bundled into rolls, giving them the flexibility of any of the uses of a fiber roll.

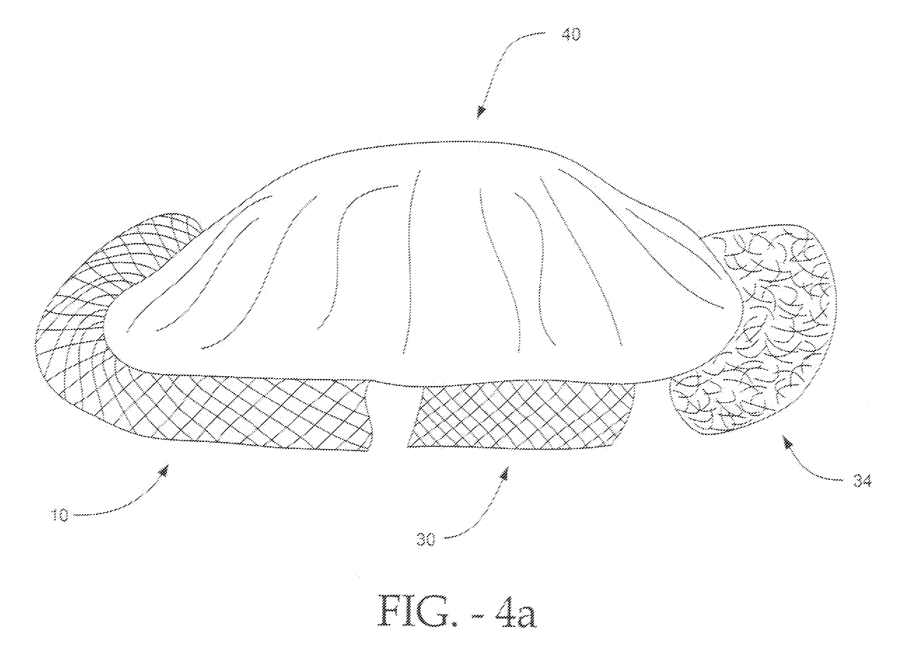

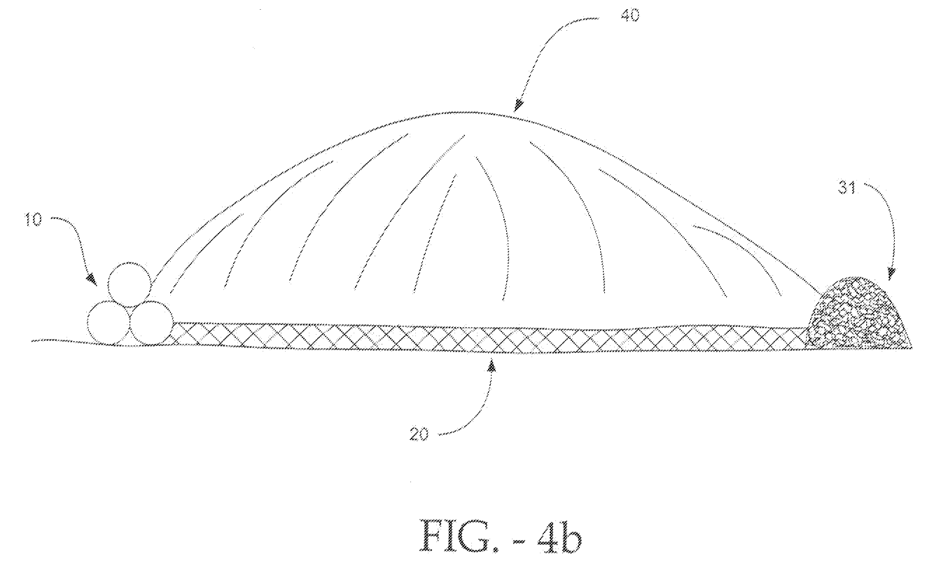

Turning now to FIGS. 4a and 4b illustrate the use of the disclosed compositions in ERBs used in the remediation of runoff water from livestock waste, contaminated soil and landfill remediation. In FIG. 4a, a side view of fiber roll 10, a bag berm 30, and a berm created on-site 31, surrounding a manure pile 40. In FIG. 4b, a cross section through the manure pile 40 resting on blanket 20, and surrounded by fiber roll 10 and berm created on-site 31. In this application it is desirable to adsorb ammonia; the volatilization of which creates serious odor problems, and absorb urine within the manure to prevent these constituents from being leached from the pile. In constructing the manure pile site, a blanket can be placed on the ground below the manure, while fiber rolls or berms surround the pile to prevent ammonia and urine from running off or leaching into the soil. It is contemplated that blankets can be interspersed in the manure pile as it is built, and eventually act to cover a completed pile. Such use of additional blankets acts to enhance absorption and/or degradation of the manure, if desired. A blanket can be placed initially, with manure layered over the blanket, and successive layers of blankets and manure stacked to build a layered pile. If desired, an absorbent, biodegradable paper can be used to contain the pile once the pile has reached a desired height. The absorbent, biodegradable paper can also be layered among the layers of blankets and manure. Further, shredded paper can be used with or without straw or other fiber around the base of the pile to enhance absorption and structural integrity of the pile. The blankets interspaced between the manure can contain carbon impregnated paper fiber in order to enhance absorption and structural integrity of the manure pile. Similarly, stacks and rows of fiber rolls or sequential rows of berms can be used to treat runoff from a manure pile and to add structural integrity to the pile.

Fecal waste from an infected host frequently carries bacteria and other organisms which cause diseases such as typhoid fever, paratyphoid fever, bacillary dysentery, infectious hepatitis and others. Disease-causing organisms are transmitted from host to host in many ways including through a contaminated water supply. Human and/or livestock populations concentrated together with a stream may result in contamination of water supplies by sewage or fecal wastes. As the proximity and density of livestock animals in the vicinity of streams increases, the frequency of E. coli infections in human populations increases. E. coli are bacteria that normally live in the intestines of humans and animals. Although most strains are harmless, several are known to produce toxins that can cause diarrhea. One particular E. coli strain called O157:H7 can cause severe diarrhea, kidney damage and has been attributed as causing human fatalities. E. coli O157:H7 infection can be caused by eating contaminated food. Cattle are the principal source of E. coli O157 infection; they carry E. coli O157 in their intestines. Changes in the preparation of animals for slaughter and in slaughter and processing methods can decrease the contamination of carcasses with E. coli O157 and the subsequent contamination of the environment. Testing for E. coli O157 can decrease incidence of illnesses due to this bacteria. Cattle manure is an important source of E. coli O157. Manure can contaminate the environment, for example via streams that flow through produce fields. If the water in the streams is used for irrigation, pesticide application, or washing of produce then the E. coli can contaminate the produce. ERBs can decrease environmental contamination due to bacteria and thereby improve the safety of produce. An ERB for treating bacteria from aqueous run-off material can be produced by introducing a container in which an anti bacterial agent is deposited within the ERB. The container can be surrounded by a fiber all of which can be held within the outer covering of the ERB. Additionally activated carbon or charcoal can be used to surround the container, within the ERB outer covering, to remove excess chlorine and other reaction products such as trihalomethanes from the aqueous run-off material.

An embodiment of the composition for the application of FIGS. 4a and 4b used as the fillings 14, 24, and 34, of the fiber roll 10, blanket 20, and bag berm 30 respectively, as well as berm created on-site 31, is comprised of the natural fiber, rice straw, the processed fiber, carbon impregnated paper for removal of ammonia, and additional adsorbents vermiculite or perlite or a combination thereof, to enhance the selectivity and capacity for removal of the targeted substances into the ERBs as they leach from the waste pile. Additional materials extending the function of the composition can be added and include suitable aggregation agents or absorbents, or combinations thereof. An exemplary covering material for this application is biodegradable or photodegradable, as described above. As will be appreciated by those of skill in the art, while this embodiment is described in terms of manure and stockyards, other types of excrement can be treated using the described composition of this type without departing from the scope of this disclosure.

In an embodiment of the present invention, fillings 14, 24, and 34, of the fiber roll 10, blanket 20, and bag berm 30 respectively, as well as berm created on-site 31, are comprised of a natural fiber, a processed fiber, and a retention agent. In an embodiment of the present invention, a retention agent enhances the selectivity and capacity for removal of the targeted substances into the ERBs as they leach from contaminated soil and other landfill remediation sites. In an embodiment of the present invention, ERBs are used together with clay and plastic barriers to direct the location of water run-off through the ERBs. In an embodiment of the invention, the presence of contaminants in the run-off water is monitored and the ERBs are replaced or regenerated when they do not function to remove contaminants.

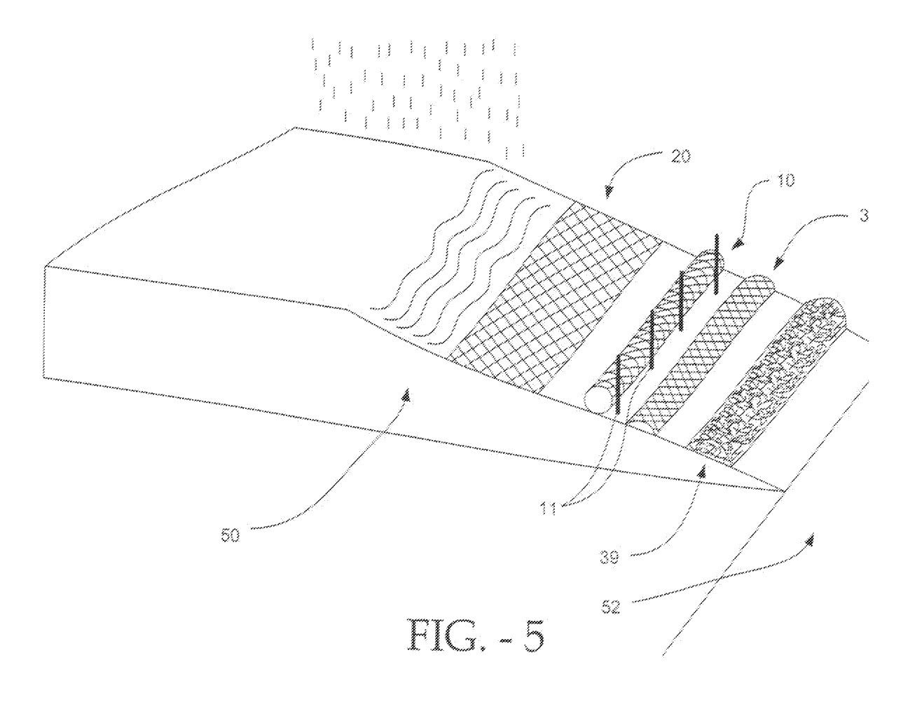

FIG. 5 illustrates a variety of ERBs that may utilize the disclosed composition in erosion control, sediment control, and additionally for treatment of storm water runoff. Hillside 50 sloping towards roadway 52 create the conditions for runoff 54. Such runoff may not only erode the hillside, carrying with it valuable topsoil, but may carry with it additionally a variety of manmade pollutants, e.g. pesticides, herbicides, fertilizers, and nutrients, as well as natural substances, such as humic acid, fulvic acid, tannic acid, and humin, potentially problematic as pollutants. Environmental remediation barriers that are useful for multifunctional purposes, including the treatment of storm water runoff are blankets 20, fiber rolls 10, bag berms 30, and berms created on-site 31. The installation of ERBs is well described, for instance in Construction Storm Water Pollution Bulletin, 4(11), 2000; a publication by the California Transit Authority. For fiber rolls, stakes 11 are used to keep the fiber roll barrier in place. Though shown on a hillside setting, the composition of this application is designed to treat runoff from a variety of surfaces, such as asphalt or concrete in a variety of residential, industrial, recreational, and agricultural settings.

An embodiment of the disclosed composition for the application of FIG. 5 used as the fillings 14, 24, and 34, of the fiber roll 10, blanket 20, and bag berm 30 respectively, as well as berm created on-site 31, is comprised of the natural fiber, rice straw, coir, the processed fiber, carbon impregnated paper for removal of pollutants, and additionally aggregating agents, gypsum and polyacrylamide. Vermiculite or perlite, or combinations thereof may be added to enhance the selectivity and capacity for removal of the targeted substances. Other materials extending the function of the composition can be added and include additional aggregation agents, adsorbents, or absorbents, or combinations thereof. An exemplary covering material for this application is photodegradable, as previously described. As will be appreciated by those of skill in the art, while this embodiment is described in terms of multifunctional application for environmental remediation of a hillside, other types of surfaces found in residential, industrial, recreational, and agricultural settings can be treated using a composition of this type without departing from the scope of this disclosure. For instance, the disclosed compositions of this embodiment can be used in conjunction with surfaces additionally contaminated with hydrocarbon accumulation, such as parking lots or roadways.

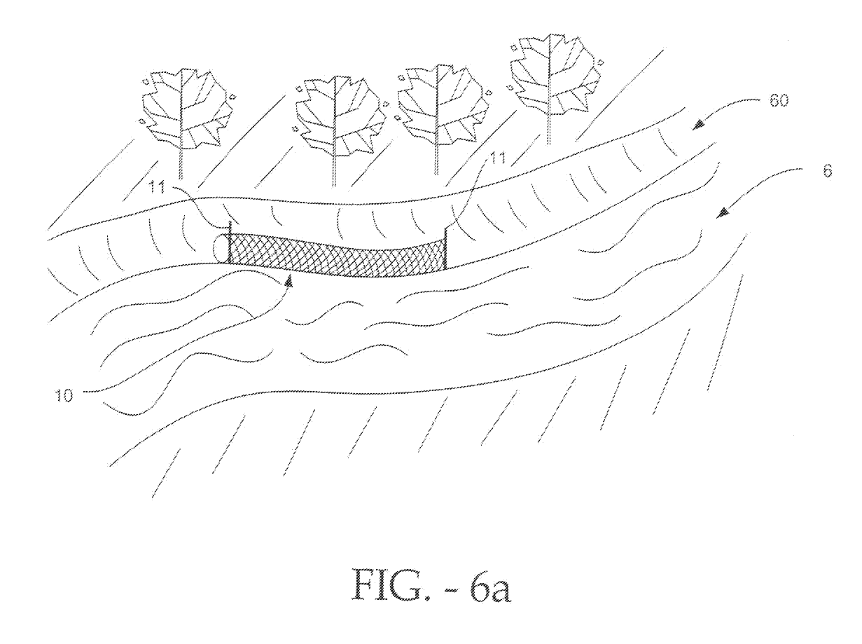

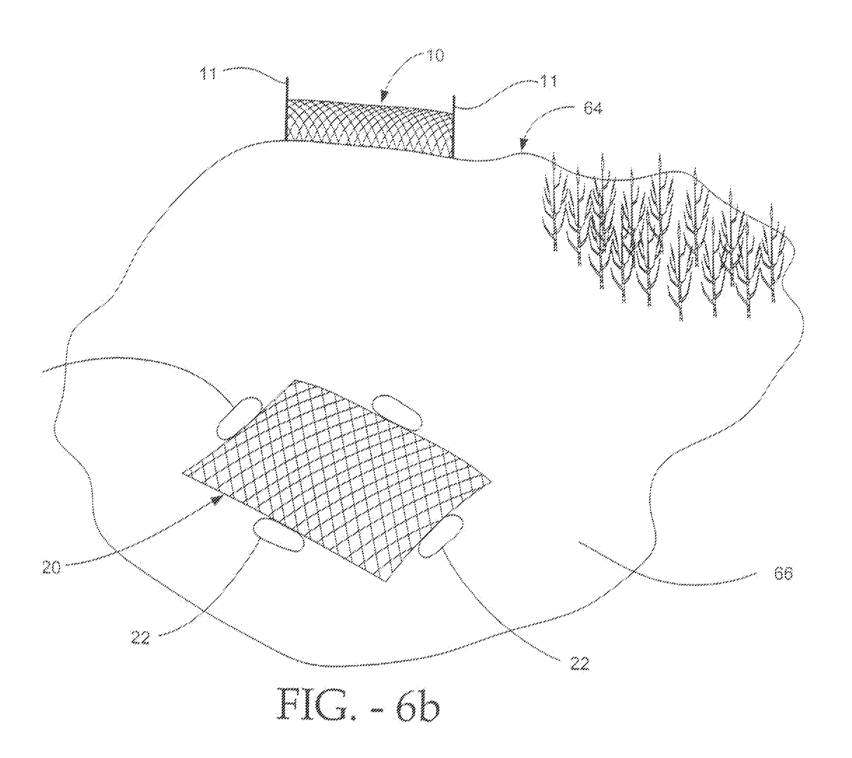

In reference to FIGS. 6a and 6b, ERBs utilizing the disclosed composition in the environmental remediation of waterways are illustrated. In this application, multifunctional purposes in addition to those mentioned in the above exemplary applications would be revetment of banks and remediation of eutrification, e.g. for pond or lake clarification of algae. In FIG. 6a, a fiber roll 10 is shown installed with stakes 11, as previously described, in order to support sloping bank 60, in continuous contact with river, 62. Similarly, in FIG. 6b, fiber roll 10 is installed using stakes 11 to support shore 64 of lake 66. Additionally, blanket 20 is shown disposed on lake 66, installed with floatation devices 22. As will be described in more detail, blanket 20 in FIG. 6b is used for remediation of eutrification of ponds, lakes, streams, and the like.

In the application illustrated in FIGS. 6a and 6b, an embodiment of the composition utilizes a combination of natural fibers, flax and barley straw, and the natural fiber, paper. For uses associated with semi-aquatic communities, such as the application of environmental remediation of a riparian community or stream or lake bank, suitable filling also includes kenaf and ramie. Depending on the application and type of ERB used, other materials extending the function of the described composition can be added including aggregation agents, adsorbents, absorbents, germicides, germistats, or combinations thereof. An exemplary covering material for this application is photodegradable or biodegradable, as described above. As will be appreciated by those of skill in the art, the compositions used in ERBs represented in FIGS. 6a and 6b could be located along the bank of other bodies of water without departing from the scope of this disclosure.

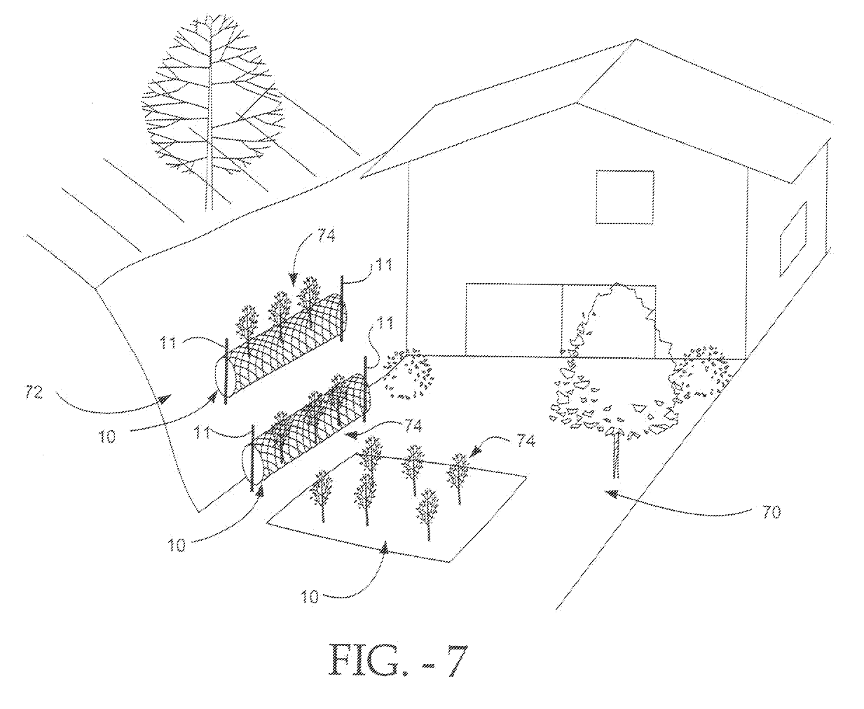

FIG. 7 depicts the use of the disclosed compositions in fiber rolls 10 and mats 20 for home garden use. Backyard 70, bounded on one side by sloping hillside 72 is shown using fiber rolls 10 installed on the sloping hillside 72 using stakes 11, while a mat is shown in backyard 70. Plants 74 are shown to be growing out of the fiber rolls 10 and the blanket 20. In addition to any of the embodiments of the disclosed compositions described above, plant material may be added, so that an additional function served is re-vegetation. Examples of suitable plant material include one or more of seeds, bulbs, rhizomes, cuttings, and seedlings. An exemplary covering material for this application is photodegradable or biodegradable, or combinations thereof, as previously described. As will be appreciated by those of skill in the art, while this embodiment is described in terms multifunctional application for home use, other types of residential, industrial, recreational, and agricultural settings can be treated using re-vegetation without departing from the scope of what is disclosed herein. For instance, the multifunctional compositions used for re-vegetation can also be used in forests, golf courses, waterways, and on embankments abutting roadways, etc.

Example embodiments of the methods, systems, and components of the present invention have been described herein. As noted elsewhere, these example embodiments have been described for illustrative purposes only, and are not limiting. Other embodiments are possible and are covered by the invention. Such embodiments will be apparent to persons skilled in the relevant art(s) based on the teachings contained herein.

Thus, the breadth and scope of the present invention should not be limited by any of the above-described exemplary embodiments, but should be defined only in accordance with the following claims and their equivalents.

What is claimed:

1. A device for treatment of aqueous run-off material from a land-fill comprising:
(a) an outer covering;
(b) one or more fiber material;
(c) one or more binding agent; and
(d) one or more reactive agent.

2. The device of claim 1, wherein the one or more reactive agent is an antibacterial agent.

3. The device of claim 1, wherein the binding agent adjusts the solubility of the reactive agent.

4. The device of claim 1, further comprising one or more inner container wherein the reactive agent is contained within one or more inner container.

5. The device of claim 4, wherein the one or more inner container has a pore size between:
a lower limit of approximately 10⁻¹⁰ m; and
an upper limit of approximately 10⁻³ m.

6. The device of claim 5, wherein the reactive agent is at least partially retained in the outer covering by the action of one or both the inner container and the binding agent.

7. The device of claim 1, further comprising one or more absorbent.

8. The device of claim 7, wherein one or more of the absorbent is selected from the group consisting of activated carbon and charcoal.

9. The device of claim 1, further comprising one or more modified retention agent including the fiber, the retention agent and the binding agent.

10. The device of claim 9, wherein the one or more retention agent includes material selected from the group consisting of aquatic shells, exoskeleton of anthropods, silica, mesoporous silica, hydroxy apatite, zirconia, cellulose, agarose, cepharose, polyacrylamide, polyamide, polystyrene and granulated activated carbon.

11. The device of claim 9, wherein one or more of the modified retention agent includes material derivatized with functional groups for retention of pesticides present in the aqueous run-off material.

12. The device of claim 9, wherein one or more of the modified retention agent includes material derivatized with functional groups for retention of ions present in the aqueous run-off material.

13. The device of claim 9, wherein the modified retention agent includes material derivatized with functional groups for retention of volatile organic compounds present in the aqueous run-off material.

14. A method for treating aqueous run-off material from a land fill site comprising:
positioning the contaminated material on top of an impervious blanket;
filling a plurality of fiber rolls having an outer covering with a composition including: an outer covering, a fiber, an inner container and a retention agent; and
installing the plurality of fiber rolls at one or more positions on a perimeter of the impervious blanket where aqueous run-off material will exit the site, including the steps of;
linking the plurality of fiber rolls; and
fixing the linked fiber rolls securely in position around the contaminated site.

15. The method of claim 14, further comprising positioning an impervious blanket on top of the land fill site to direct rainfall outside the outer perimeter of the site.

16. A device for treatment of aqueous run-off material prior to entering a watercourse comprising:
(a) an outer covering;
(b) a fiber material, wherein the fiber material is contained within the outer covering;
(c) one or more inner container;
(d) one or more reactive agent, wherein the one or more reactive agent are initially positioned within the one or more inner container of the device; and
(e) one or more binding agent.

17. The device of claim 16, wherein one or more of the reactive agent is partially contained within one or both of the one or more inner container and the outer covering by the binding agent.

18. The device of claim 16, further comprising a modified reactive agent including the fiber, the reactive agent and the binding agent.

19. The device of claim 16, wherein the reactive agent reduces the level of phosphates in the aqueous run-off material.

20. The device of claim 16, wherein reactive agent reduces the level of nitrogen containing compounds present in the aqueous run-off material.
